(19) United States
(12) Patent Application Publication
(10) Pub. No.: US 2002/0046056 A1
(43) Pub. Date: Apr. 18, 2002

(54) System for facilitating the return of a product purchased over a computer network, such as the internet

(76) Inventors: Thomas J. Demarco, Marietta, GA (US); Bryan J. Demarco, Marietta, GA (US)

Correspondence Address: John J Daniels, 511 Foot Hills Road, Higganum, CT, 06441, US

(21) Appl. No.: 09/950,389

(22) Filed: Sep. 10, 2001

Related U.S. Application Data
(60) Provisional application No. 60/231,316, filed on Sep. 8, 2000.

(51) Int. Cl. G06F 17/60

(52) U.S. Cl. 705/1

(57) ABSTRACT

A product return facilitating procedure for facilitating the return of a product purchased online. The product is returnable at the discretion of the consumer and under predetermined rules. An enrollment procedure may include the activation of a hyperlink by the consumer indicating a request for enrollment offer in the system for facilitating the return of the purchased product. Alternatively, the consumer may have to enroll in the system only one time via an online application, with the online merchants who utilize the system providing customer and product-specific purchase data at the time a purchase is made. Once the purchase data is obtained by the inventive system, an enrollment email notification is automatically generated and sent to the consumer indicating the terms and conditions for returning the product. The enrollment email may include an indication informing the consumer that the product return requesting procedure requires replying to the enrollment email. The enrollment email also may include identifying-information dependent on the consumer data and/or the product purchase data. The product return facilitating procedure includes the steps of providing a product return requesting procedure for the consumer to request a return of the purchased product, and providing a product return transporting procedure for transporting the purchased product to a designated product return location.

CROSS REFERENCE TO RELATED APPLICATIONS

This is a U.S. Utility Application of U.S. Provisional Application Ser. No. 60/231,316, filed Sep. 8, 2000.

### BACKGROUND OF THE INVENTION

The present invention pertains to a system for facilitating the return of a product. More particularly, the present invention pertains to a system for facilitating the return of a product purchased over a computer network, such as the Internet.

Recently, e-Commerce has seen explosive growth on the Internet. There are many online merchants with websites offering products for sale to consumers. However, unlike a conventional brick and mortar store, online shoppers are not able to adequately inspect a product before making a purchase, and must rely on online photos and descriptions of products when making a purchase decision. Further, unlike a conventional brick and mortar store, an online merchant is usually located very far from the location of the consumer, making it extremely difficult and unlikely for the consumer to physically personally transport a purchased product back to the online merchant for a product return. The result is that often times a consumer will be reluctant to complete the purchase of a product online because of the lack of physical inspection of the product before purchase and because of the difficulty of returning the product should it not be what the consumer expected from the online description.

According to Boston Consulting, 65% of online shoppers abandon the checkout process before the final purchase. The lack of an easy return method was found to be the second most important reason for not shopping online (security was the first). Jupiter Communications revealed that 40% of online shoppers would buy more items if returns were easier, and 85% stated that the return process was a very important consideration when making an online purchase.

Typically, a product can be returned within a set time period (e.g., 30 days from the purchase date). Usually, the consumer must pay for the return shipping costs. To request the return of a product, a consumer typically has to find the merchant's phone number, call the number and speak with a representative of the merchant. Often there is a long wait on hold before speaking with the representative. The consumer then requests the return of the product and usually has to provide details such as the purchase invoice number, which is then checked by the representative to validate the product return. A return number code (RMA number) is usually given to the consumer, who is instructed to write the return number code on the shipping box along with a return address for the online merchant. Once the shipping package is prepared, and the return number code and return address applied to it, the consumer brings the package to a drop-off location of a shipping courier, or otherwise arranges to have the package shipped back to the online merchant.

This process is time consuming, inconvenient and, because of the return shipping costs, relatively expensive for the consumer and has been demonstrated to be a detracting factor in e-commerce transactions. Accordingly, there is an important need for a system for facilitating the return of a product purchased online.

### SUMMARY OF THE INVENTION

It is an object of the present invention to provide a system for facilitating the return of a product purchased over a computer network, such as the Internet. It is another object of the present invention to provide a system for facilitating the return of a product purchased from an online source of product information, such as a website, wherein the website contains an online solicitation pertaining to an offer for the sale of a product by an online merchant.

A product return facilitating procedure is provided for facilitating the return of the purchased product at the discretion of the consumer and under predetermined rules. An enrollment procedure may include the activation of a hyperlink by the consumer. The activation of the hyperlink indicates a request for enrollment in a service or system for facilitating the return of the purchased product. Alternatively, the consumer may have to enroll in the system only one time via an online application, with the online merchants who utilize the system providing customer and product-specific purchase data at the time a purchase is made. Once the purchase data is obtained by the inventive system, an enrollment email notification can be automatically generated and sent to the consumer indicating the terms and conditions for returning the product. The enrollment email may include an indication informing the consumer that to return a product, (using a product return requesting procedure), requires replying to the enrollment email. The enrollment email also may include identifying-information dependent on the consumer data and/or the product purchase data.

The product return facilitating procedure includes the steps of providing a product return requesting procedure for the consumer to request a return of the purchased product, and providing a product return transporting procedure for transporting the purchased product to a designated product return location.

In accordance with an implementation of the present invention, the product return requesting procedure comprises the steps of receiving an electronic message from the consumer requesting the return of the purchased product. The electronic message may be transmitted via an email (such as a reply to the enrollment email), or the electronic message may be transmitted via an online form.

For example, the product return requesting procedure includes receiving a reply to the enrollment email from the consumer indicating a product return request. The product return transporting procedure includes validating the product return request depending on the predetermined rules and the identifying-information, and a transportation arrangement procedure for arranging for the transportation of the purchased product to the designated product return location.

The purchase data can be used to obtain useful demographic information relating to a specific consumer, and to identify consumer trends. This demographic information can be utilized for advertising and other product promotional uses. An advertiser can qualify sales leads by utilizing consumer specific data volunteered when completing an online enrollment form, and/or by utilizing product specific data supplied by the merchant. This demographic information, along with other “data mining” information obtained from the consumer and merchant, can be used to create a consumer profile of a specific consumer.

Furthermore, such “data mining” information obtained for a number of consumers and/or merchants can be used collectively to identify consumer trends, such as product demand, online spending habits, effect of e-commerce facilitators such as the inventive product return service, and the like.

### BRIEF DESCRIPTION OF THE INVENTION

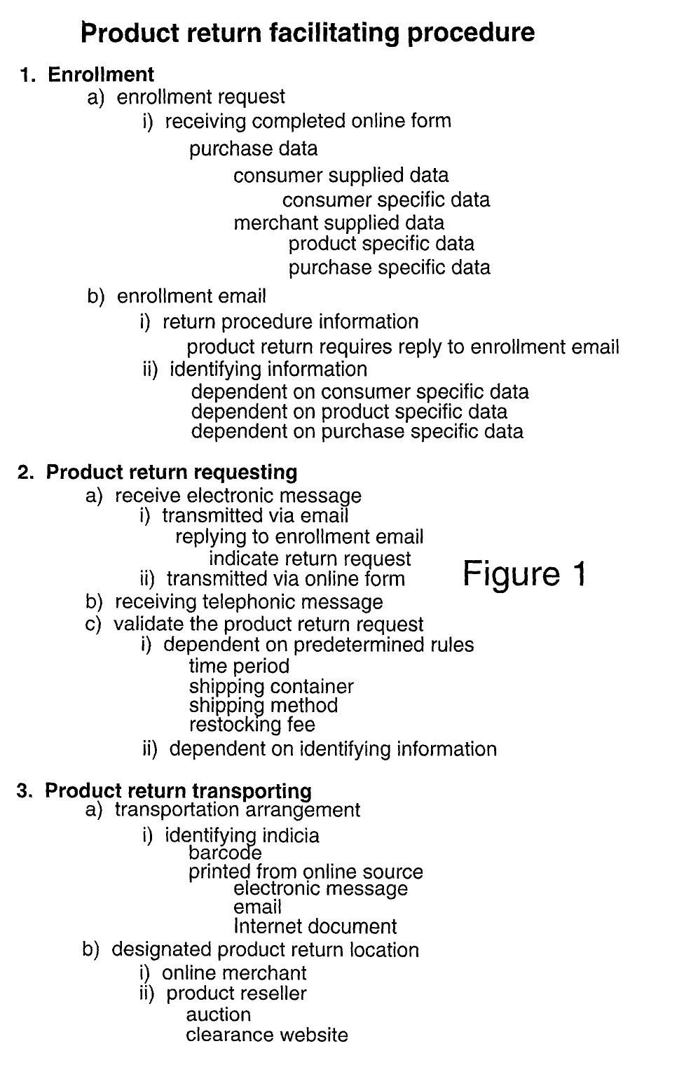

FIG. 1 is a schematic overview of the inventive system for facilitating the return of a product purchased over a computer network, such as the Internet;

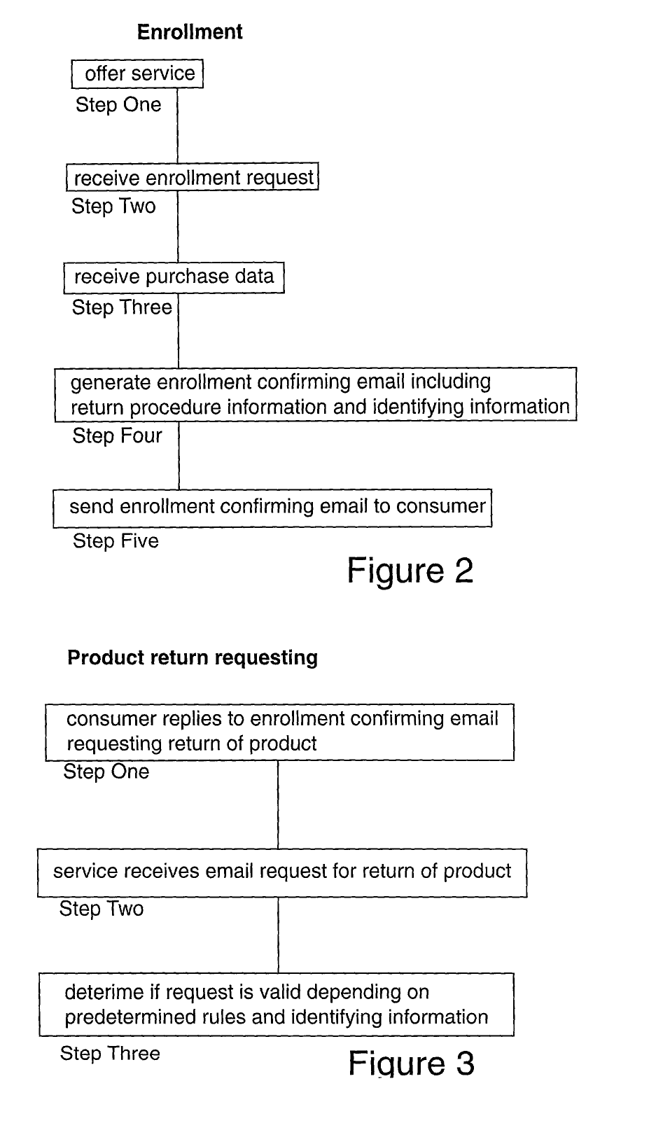

FIG. 2 is a flowchart showing the steps of one implementation of the enrollment procedure for the inventive system for facilitating the return of a product purchased over a computer network, such as the Internet;

FIG. 3 is a flowchart showing the steps of one implementation of the product return requesting procedure for the inventive system for facilitating the return of a product purchased over a computer network, such as the Internet;

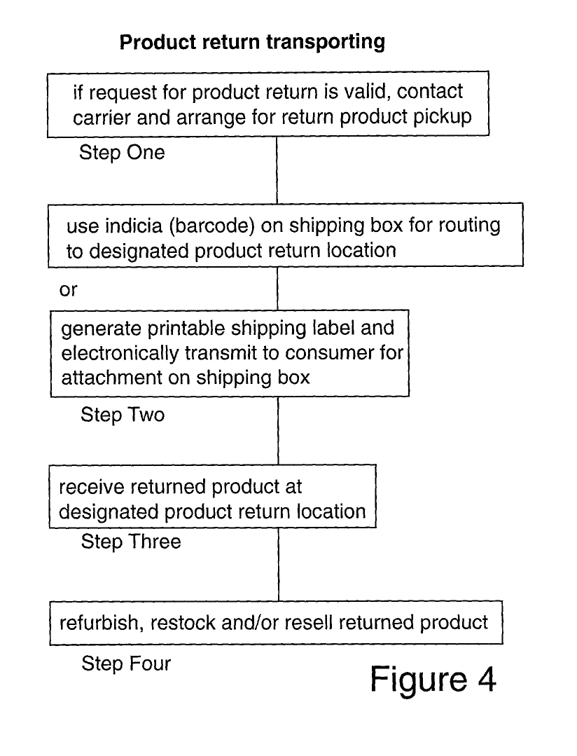

FIG. 4 is a flowchart showing the steps of one implementation of the product return transporting procedure for the inventive system for facilitating the return of a product purchased over a computer network, such as the Internet;

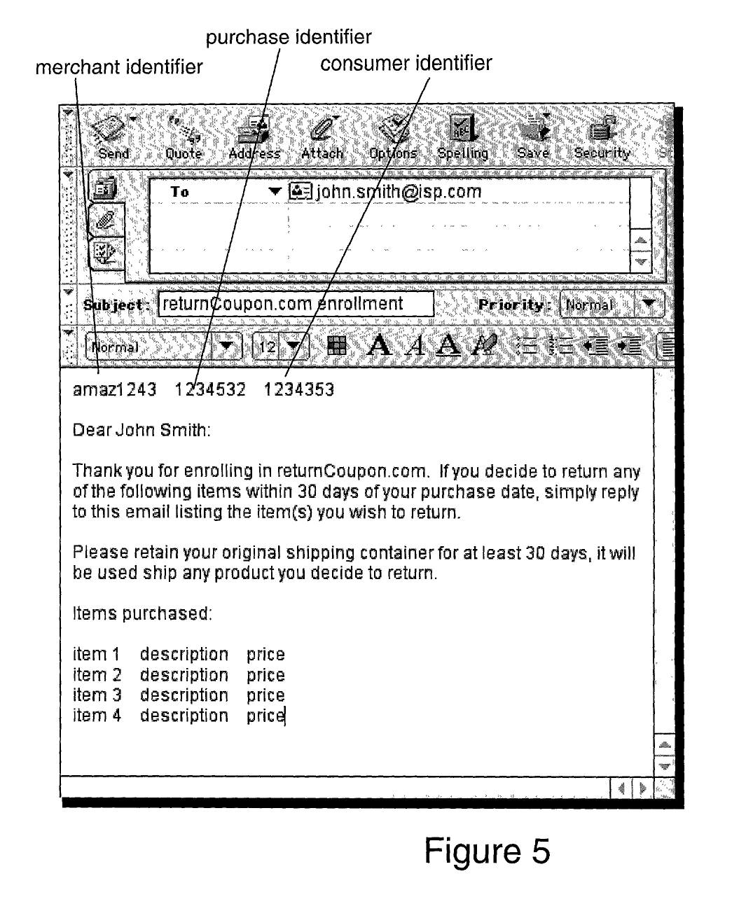

FIG. 5 is an illustration showing an enrollment email with identifying-information in according with one implementation of the enrollment procedure of the inventive system for facilitating the return of a product purchased over a computer network, such as the Internet;

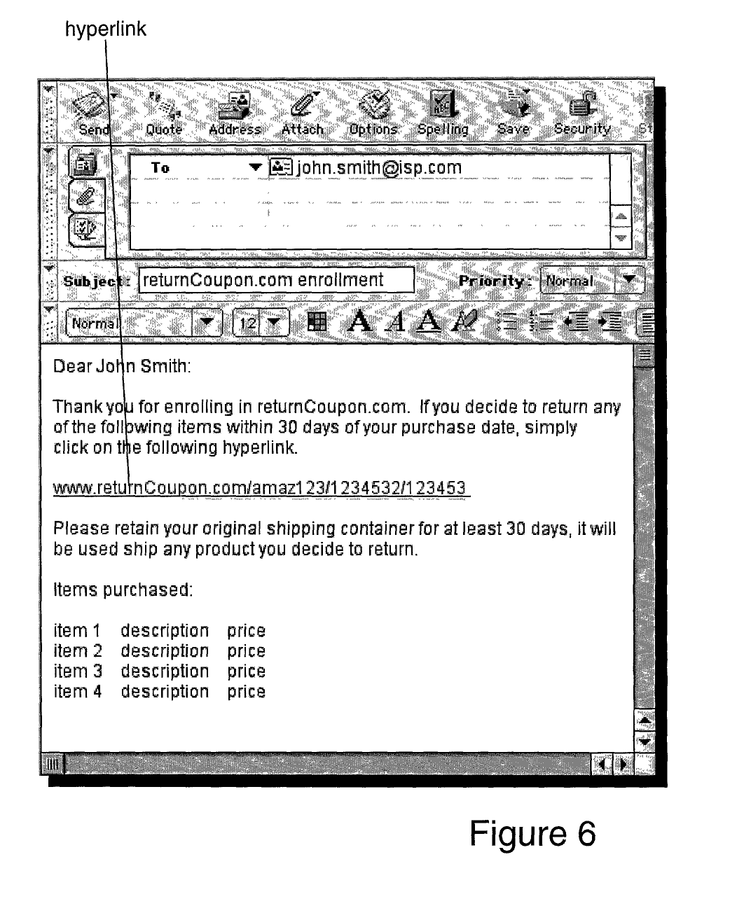

FIG. 6 is an illustration showing an enrollment email with an identifying hyperlink according to another implementation of the enrollment procedure of the inventive system for facilitating the return of a product purchased over a computer network, such as the Internet; and

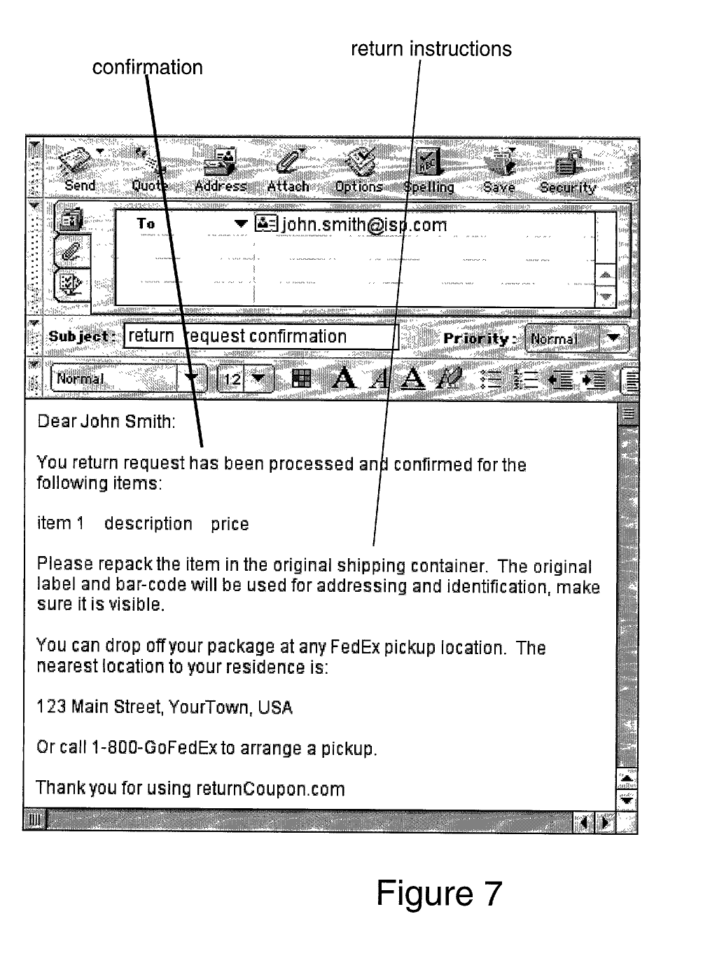

FIG. 7 is an illustration showing a return request confirmation email automatically generated in reply to a request for returning a product purchased online.

### DETAILED DESCRIPTION OF THE INVENTION

For purposes of promoting an understanding of the principles of the invention, reference will now be made to the embodiments illustrated in the drawings and specific language will be used to describe the same. It will nevertheless be understood that no limitation of the scope of the invention is thereby intended, there being contemplated such alterations and modifications of the illustrated system, and such further applications of the principles of the invention as disclosed herein, as would normally occur to one skilled in the art to which the invention pertains.

FIG. 1 is a schematic overview of the inventive system for facilitating the return of a product purchased over a computer network, such as the Internet. In accordance with the present invention an enrollment procedure (1. Enrollment) is provided for enabling a consumer to enroll in a service for facilitating the return of the product. The service includes a system that makes it easy for a consumer to return a product purchased online, thereby overcoming or lessening one of the major deterrences to e-commerce.

A product return facilitating procedure is provided for facilitating the return of the purchased product at the discretion of the consumer and under predetermined rules. The product return facilitating procedure includes the steps of providing a product return requesting procedure (2. Product return requesting) for the consumer to request a return of the purchased product, and providing a product return transporting procedure (3. Product return transporting) for transporting the purchased product to a designated product return location. Through the implementation of the inventive system, a service is provided in which a consumer is relieved of much of the burden involved in returning a product purchased over the Internet. The inventive system utilizes efficient communication mechanisms, such as an automatically generated enrollment email and email reply, to enable a consumer to conveniently and securely request and transact the return of a product purchased over the Internet. The inventive system overcomes much of the burden on an online merchant in implementing a convenient and secure return policy for a product purchased over the Internet. The inventive system automatically validates a request for a product return by comparing identifying-information and product purchase data, which may be included in the enrollment email, with predetermined rules and product return request acceptance policies. The implementation of this system results in benefits to both the consumer and the online merchant, with more efficient product return transactions encouraging e-commerce.

In accordance with an implementation of the present invention, the product return requesting procedure comprises the steps of receiving an electronic message from the consumer requesting the return of the purchased product. The electronic message may be transmitted via an email, or the electronic message may be transmitted via an online form. In this case, the consumer may reply to an enrollment email and/or visit a website to initiate the request for the return of the product. In accordance with another implementation of the present invention, the product return requesting procedure comprises the steps of receiving a telephonic message from the consumer requesting the return of the purchased product. In this case, the consumer may call a telephone number and speak with a human operator or an automated voice recognition system to initiate the request for the return of the product.

The enrollment procedure may include the activation of a hyperlink by the consumer indicating a request for enrollment offer in the system for facilitating the return of the purchased product. The hyperlink may be provided at the merchant's website, such as just prior to check out, during the online purchasing process. The hyperlink-activated enrollment request may thus be made at or about a time of receiving the acceptance of the offer for the sale of said product for purchase by the consumer. Alternatively, the consumer may have to enroll in the system only one time via an online application, with the online merchants who utilize the system providing customer and product-specific purchase data at the time a purchase is made. Once the purchase data is obtained by the inventive system, an email notification can be automatically generated and sent to the consumer indicating the terms and conditions for returning the product.

This purchase data can provide useful demographic information pertaining to the consumer. This demographic information can be utilized for advertising and other product promotional uses. For example, an advertiser may be interested in consumer specific data that is volunteered by the consumer when completing an online enrollment form, along with the product specific data supplied by the merchant. This information, along with other “data mining” information obtained from the consumer and merchant, can be used to create a consumer profile of a specific consumer. In addition, or alternatively, this “data mining” information of a number of consumers and/or merchants can be used collectively to identify consumer trends, such as product demand, online spending habits, effect of e-commerce facilitators such as the inventive product return service, etc., etc.

The enrollment request procedure may include receiving a completed online form including purchase data with at least a portion of the purchase data filled in by the consumer. Further, at least a portion of the purchase data comprises predetermined data may be supplied by the online merchant, and include the consumer specific data and product specific data.

In accordance with one implementation of the inventive system, the enrollment procedure includes the automatic generation of an enrollment email sent to the consumer. The enrollment email includes an indication informing the consumer that the product return requesting procedure requires replying to the enrollment email. The enrollment email also includes identifying-information dependent on the consumer data and/or the product purchase data. Further, the product return requesting procedure includes receiving a reply to the enrollment email from the consumer indicating a product return request. The product return transporting procedure includes validating the product return request depending on the predetermined rules and the identifying-information, and a transportation arrangement procedure for arranging for the transportation of the purchased product to the designated product return location.

In accordance with an implementation of the inventive system, the transportation arrangement procedure includes the utilization of an identifying indicia provided for the return of the purchased product. The identifying indicia may include a barcode portion of a label affixed to a product shipping container, with the same barcode and shipping container used for the transporting the product to and from the consumer. In addition, or alternatively, the identifying indicia may be printed indicia obtained via an online indicia source in response to the product return request. The online indicia source may be an email, electronic message or Internet document. The Internet document may be, for example, a printer-friendly HTML page the includes a shipping label automatically filled out with information obtained from the purchase data. In this case, the consumer and product-specific purchase data may be stored in a database that is accessed when the consumer logs into a website that includes the HTML page.

The designated product return location is the online merchant, in which case the product is returned directly or indirectly to the online merchant for refurbishing, restocking and/or reselling. Alternatively, the designated product return location can be provided as a clearinghouse for receiving returned products from various online merchants for refurbishing (if necessary) and reselling the product to another consumer. The returned product may be resold, for example, in an auction or clearance-type online sales process.

FIG. 2 is a flowchart showing the steps of one implementation of the enrollment procedure for the inventive system for facilitating the return of a product purchased over a computer network, such as the Internet. As shown, in accordance with this implementation, an offer for the inventive system is made to the consumer (Step One). The offer may be, for example, provided as an incentive to utilize an online merchant with a description of how the system works included in the home page, checkout page or other portion of the merchant's website. The offer may be provided in a separate HTML document or website, with a hyperlink (such as “click here to learn about returnCoupon.com”) provided at the merchant's website. The consumer may select to enroll with the inventive system, and thus send an enrollment request. The enrollment request may be, for example, an email, or an automatically generated form with data supplied by the merchant and/or the consumer. The enrollment request is received by the inventive system, such as through an electronic, email or online form transaction (Step Two). In addition to the enrollment request, purchase data containing consumer, product and merchant specific information, or the like is received (Step Three). An enrollment confirming email is generated including the return procedure information and identifying-information (Step Four), and this email is sent to the consumer (Step Five).

FIG. 3 is a flowchart showing the steps of one implementation of the product return requesting procedure for the inventive system for facilitating the return of a product purchased over a computer network, such as the Internet. As shown, in accordance with this implementation, when a consumer desires to return a product purchased online the consumer replies to the enrollment confirming email requesting the return of the product (Step One). The inventive system receives the email reply containing the request for the return of the product (Step Two). It is then determined if the request is valid. This determination can be automatically made by a computer depending on the predetermined rules and identifying-information (Step Three). For example, a database can be maintained of records pertaining to the merchants, consumers and product purchases covered by the inventive system. When a request is made for returning a product, the identifying-information is used along with the database records (including the product return rules of the particular merchant) to determine if the return request should be authorized.

FIG. 4 is a flowchart showing the steps of one implementation of the product return transporting procedure for the inventive system for facilitating the return of a product purchased over a computer network, such as the Internet, In accordance with this implementation, if it is determined that the product request is valid, a carrier may be contacted and pickup of the product arranged for returning it to the merchant (Step One). To facilitate the return procedure, the same shipping container and indicia (e.g., barcode, shipping label) on the shipping container that was used to bring the product to the consumer can be utilized to return the product. Arrangements can be made with shipping carriers for this purpose, and also to get reduced shipping costs because of the quantity of packages that will be shipped according to the implementation of the inventive system. Alternatively, a printable shipping label can be automatically generated and electronically transmitted to the consumer for attachment to the shipping container (Step Two). The shipping carrier ships the product back to a designated product return location (Step Three). As discussed above, the designated product return location may be the online merchant or a clearinghouse maintained for the resale of returned products. In either event, the return product is then refurbished if necessary, restocked and/or resold to another consumer (Step Four).

In accordance with one implementation of the inventive system, a consumer pays a fee when completing the enrollment procedure. As an incentive to enrollment, the fee may be significantly less than the return shipping costs that would be paid by the consumer for returning the product through conventional channels. Payment of this fee and enrollment in the system entitles the consumer to utilize the convenience of the inventive system (under predetermined rules and conditions) for the return of a product purchased online.

FIG. 5 is an illustration showing an enrollment email with identifying-information in according with one implementation of the enrollment procedure of the inventive system for facilitating the return of a product purchased over a computer network, such as the Internet. In this example, the enrollment email is automatically generated when the consumer requests enrollment in the inventive system. This implementation of the enrollment email includes identifying-information provided at the top of the message body. In this case, the identifying-information includes a merchant identifier, a purchase identifier and a consumer identifier. This information is also maintained for indexing a purchase data database, and automatically detected and used for return authorization when the consumer requests a product return.

FIG. 6 is an illustration showing an enrollment email with an identifying hyperlink according to another implementation of the enrollment procedure of the inventive system for facilitating the return of a product purchased over a computer network, such as the Internet. In this example, a hyperlink that is unique for this merchant, consumer, product purchase combination is generated and a website maintained that can be accessed by clicking on the hyperlink. When a consumer wishes to return a product, this hyperlink is used to bring the consumer to an appropriate Internet document, form or webpage, which may include instructions, product return authorization scripts, printable shipping labels, etc., for facilitating the return of the product.

FIG. 7 is an illustration showing a return request confirmation email automatically generated in reply to a request for returning a product purchased online. In this case, arrangements are made with a selected shipping carrier to re-use the shipping label and barcode that was used to transport the product to the consumer. The consumer is instructed on how to repackage the product and how to arrange the shipping of the product back to the designated return location. Thus, the return of a product purchased over a computer network, such as the Internet, is facilitated. Through the implementation of the inventive system, e-commerce transactions are encouraged and the purchasing of products online made more acceptable to the consumer.

With respect to the above description, it is realized that the optimum procedures, steps and processes are dependent on the particular aspects of a given website, the Internet browser(s) and online documents employed and other computer networking considerations and are deemed readily apparent and obvious to one skilled in the art. All equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described. Accordingly, all suitable modifications and equivalents may be resorted to, falling within the scope of the invention.

1) A system for facilitating the return of a product purchased over a computer network, such as the Internet, wherein a consumer purchases a product from a source of product information such as a website containing an online solicitation pertaining to an offer for sale of the product by an online merchant, the system for facilitating the return of the product comprising the steps of: providing an enrollment procedure for enabling the consumer to enroll in a system for facilitating the return of the product; providing a product return facilitating procedure for facilitating the return of the purchased product at the discretion of the consumer and under predetermined rules, the product return facilitating procedure comprising the steps of providing a product return requesting procedure for the consumer to request a return of the purchased product, and providing a product return transporting procedure for transporting the purchased product to a designated product return location.

2) A system for facilitating the return of a product according to claim 1; wherein the product return requesting procedure comprises the steps of receiving an electronic message from the consumer requesting the return of the purchased product.

3) A system for facilitating the return of a product according to claim 2; wherein the electronic message is transmitted via an email.

4) A system for facilitating the return of a product according to claim 2; wherein the electronic message is transmitted via an online form.

5) A system for facilitating the return of a product according to claim 1; wherein the product return requesting procedure comprises the steps of receiving a telephonic message from the consumer requesting the return of the purchased product.

6) A system for facilitating the return of a product according to claim 1; wherein the enrollment procedure includes the activation of a hyperlink by the consumer indicating a request for enrollment offer in the system for facilitating the return of the purchased product.

7) A system for facilitating the return of a product according to claim 6; wherein the enrollment procedure includes receiving the hyperlink-activated enrollment request at or about a time of receiving the acceptance of the offer for the sale of said product for purchase by the consumer.

8) A system for facilitating the return of a product according to claim 7; wherein the enrollment request procedure comprises receiving a completed online form including purchase data with at least a portion of the purchase data filled in by the consumer.

9) A system for facilitating the return of a product according to claim 8; wherein at least a portion of the purchase data comprises predetermined data supplied by the online merchant.

10) A system for facilitating the return of a product according to claim 9; wherein the predetermined data comprises at least one of consumer specific data and product specific data.

11) A system for facilitating the return of a product according to claim 6; wherein the enrollment procedure includes the automatic generation of an enrollment email sent to the consumer, the enrollment email including an indication informing the consumer that the product return requesting procedure requires replying to the enrollment email, the enrollment email includes identifying-information dependent on at least one of the consumer data and the product purchase data; wherein the product return requesting procedure includes receiving a reply to the enrollment email from the consumer indicating a product return request; and wherein the product return transporting procedure includes validating the product return request depending on the predetermined rules and the identifying-information, and a transportation arrangement procedure for arranging for the transportation of the purchased product to the designated product return location.

12) A system for facilitating the return of a product according to claim 11; wherein the transportation arrangement procedure includes the utilization of an identifying indicia provided for the return of the purchased product.

13) A system for facilitating the return of a product according to claim 12; wherein the identifying indicia comprises a barcode portion of a label affixed to a product transportation container.

14) A system for facilitating the return of a product according to claim 12; wherein the indentifying indicia comprises a printed indicia obtained via an online indicia source in response to the product return request.

15) A system for facilitating the return of a product according to claim 14; wherein the online indicia source comprises at least one of an email, electronic message or Internet document.

16). A system for facilitating the return of a product according to claim 1; wherein the designated product return location is the online merchant.

17). A system for facilitating the return of a product according to claim 1; wherein the designated product return location resells the product to another consumer.

18). A system for facilitating the return of a product according to claim 12; wherein the designated product return location resells the product to another consumer via an online auction.
wherein the predetermined rules include a set time period for returning the purchased product

19) A system for facilitating the return of a product according to claim 6; wherein the enrollment procedure includes the automatic generation of an enrollment email sent to the consumer, the enrollment email including an indication informing the consumer that the product return requesting procedure requires replying to the enrollment email, the enrollment email includes identifying-information dependent on at least one of the consumer data and the product purchase data; wherein the product return requesting procedure includes receiving a reply to the enrollment email from the consumer indicating a product return request; and wherein the product return transporting procedure includes validating the product return request depending on the predetermined rules and the identifying-information, and arranging for the transportation of the purchased product to the designated product return location.

20) A system for facilitating the return of a product according to claim 1: wherein the source of online information comprises an Internet website and wherein the means for receiving the acceptance of the offer comprises a hyperlink provided at the Internet website activatable by the consumer.
